(19) United States
(12) Patent Application Publication
(10) Pub. No.: US 2026/0186392 A1
(43) Pub. Date: Jul. 2, 2026

(54) ADJUSTMENT MODULE AND PROJECTION APPARATUS

(71) Applicant: Coretronic Corporation, Hsin-Chu (TW)

(72) Inventors: Guang-Jhih Jheng, Hsin-Chu (TW); Wen-Ching Ho, Hsin-Chu (TW); Yung-Chuan Tseng, Hsin-Chu (TW)

(73) Assignee: Coretronic Corporation, Hsin-Chu (TW)

(21) Appl. No.: 19/417,174

(22) Filed: Dec. 11, 2025

(30) Foreign Application Priority Data
Dec. 26, 2024 (CN) 202423229430.9

(51) Int. Cl. G03B 21/14; G02B 7/198; G03B 21/20

(52) U.S. Cl. CPC G03B 21/142; G02B 7/198; G03B 21/2066

(57) ABSTRACT

An adjustment module for adjusting an optical element and a projection apparatus including the adjustment module are provided. The adjustment module includes a plate, a holder, a first adjustment bar, a second adjustment bar, and a third adjustment bar. The optical element is fixed on the holder, and the holder is located between the plate and the optical element. The first and second adjustment bars are respectively disposed through the plate and move along a first adjustment axis and a second adjustment axis. The third adjustment bar is disposed through the plate and moves along a third adjustment axis. The first to third adjustment bars, together with the first and second fitting holes and the abutting surface of the holder, allow the first to third adjustment axes to be not perpendicular to the optical element, which improves the space flexibility for installing peripheral mechanisms and improves the convenience in maintenance.

### CROSS-REFERENCE TO RELATED APPLICATION

This application claims the priority benefit of China application serial no. 202423229430.9, filed on December 26, 2024. The entirety of the above-mentioned patent application is hereby incorporated by reference herein and made a part of this specification.

### BACKGROUND

### Technical Field

The disclosure relates to an adjustment module and a projection apparatus, and particularly relates to an adjustment module that is capable of adjusting an installation position and an installation angle of an optical element, and a projection apparatus using the adjustment module.

### Description of Related Art

Currently, when the optical element in a projection apparatus is an adjustable element, the optical element is placed on a holder, and the holder is locked to a positioning member through adjustment bars. During maintenance or calibration, the angle or position of the optical element may be adjusted by individually rotating the adjustment bars inward or outward relative to the positioning member. The axial direction of the screw holes to accommodate the adjustment bars and the installation angle of the adjustment bars are generally perpendicular to the optical element. That is to say, the axial direction of the screw holes is parallel to the preset normal line of the optical element. Therefore, the more inclined the design value of the optical element is, the more inclined the corresponding adjustment tool becomes, which imposes the following two problems. (1) The space near the inclined optical element needs to be reserved in the projection apparatus for the adjustment tool to pass through, and no mechanism parts can be placed there; otherwise, the mechanism parts need to be removed when adjusting the optical element, and be reinstalled after adjusting the optical element, which results in a waste of space utilization or increases the difficulty in maintenance. (2) When using the adjustment tool to rotate the adjustment bar, the adjustment tool needs to be operated at an inclined angle, which is not friendly for maintenance personnel, and it may take more time to adjust.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

The disclosure provides an adjustment module for adjusting an installation position and an installation angle of an optical element, which improves the convenience in maintenance.

The disclosure further provides a projection apparatus including the adjustment module, which has favorable projection quality.

Other objectives and advantages of the disclosure may be further understood from the technical features disclosed herein.

To achieve one or part or all of the above objectives or other objectives, an embodiment of the disclosure provides an adjustment module configured to adjust an installation position and an installation angle of an optical element. The adjustment module includes a plate, a holder, a first adjustment bar, a second adjustment bar, and a third adjustment bar. The optical element is fixed on the holder, and the holder is located between the plate and the optical element. The holder has a first fitting hole, a second fitting hole, and an abutting surface. The first adjustment bar is movably disposed through the plate and configured to move along a first adjustment axis. A first end of the first adjustment bar is disposed and fitted in the first fitting hole of the holder. The second adjustment bar is movably disposed through the plate and configured to move along a second adjustment axis. A first end of the second adjustment bar is disposed and fitted in the second fitting hole. The third adjustment bar is movably disposed through the plate and configured to move along a third adjustment axis. A first end of the third adjustment bar abuts against the abutting surface of the holder. When at least one of the first adjustment bar, the second adjustment bar, and the third adjustment bar moves along the corresponding adjustment axis, the holder and the optical element move or swing relative to the plate. The first adjustment axis, the second adjustment axis, and the third adjustment axis each have an included angle that is not 0 with a normal direction of the optical element.

To achieve one or part or all of the above objectives or other objectives, an embodiment of the disclosure provides a projection apparatus, including a light source, an optical element, the adjustment module as described above, a light valve, and a projection lens. The light source is configured to provide an illumination beam. The adjustment module is disposed on a transmission path of the illumination beam and configured to adjust an installation position or an installation angle of the optical element. The light valve is disposed on the transmission path of the illumination beam and configured to convert the illumination beam into an image beam. The projection lens is disposed on a transmission path of the image beam and configured to project the image beam out of the projection apparatus.

Based on the above, the embodiments of the disclosure have at least one of the following advantages or effects. When at least one of the first adjustment bar, the second adjustment bar, and the third adjustment bar in the adjustment module of the disclosure moves along the corresponding adjustment axis, the holder and the optical element move or swing relative to the plate. Each of the first adjustment axis, the second adjustment axis, and the third adjustment axis forms an included angle that is not 0 with the normal direction of the optical element. In other words, the adjustment axis directions of the first adjustment bar, the second adjustment bar, and the third adjustment bar are not necessarily perpendicular to the optical element. Such flexibility in design allows the first adjustment bar, the second adjustment bar, and the third adjustment bar to be disposed in directions that do not interfere with other mechanism parts in their extension directions. After opening an upper cover of the projection apparatus, maintenance personnel may directly use the external adjustment tool to engage with the adjustment module without interference from other mechanism parts, and may directly perform adjustment on the adjustment module to move the optical element to the optimized position and achieve favorable optical efficiency. Moreover, since there is no need to remove other mechanism parts first, the design of the adjustment module of the disclosure solves the problems of poor space utilization and operational difficulty in the related art, and improves the convenience in maintenance. In addition, the projection apparatus adopting the adjustment module of the disclosure has favorable projection quality.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A is a block diagram showing a projection apparatus according to an embodiment of the disclosure.

FIG. 1B is a top view showing the interior of the projection apparatus of FIG. 1A.

FIG. 2A is a perspective view showing the adjustment module of the projection apparatus of FIG. 1A.

FIG. 2B is a perspective view showing the adjustment module of FIG. 2A from another viewing angle.

FIG. 2C is a perspective view showing the adjustment module of FIG. 2A engaged with the external adjustment tool.

FIG. 2D is a cross-sectional view along line I-I of FIG. 2C.

FIG. 2E is a cross-sectional view along line II-II of FIG. 2C.

FIG. 2F is a perspective view showing the adjustment module of FIG. 2A with the plate omitted.

FIG. 3A and FIG. 3B are cross-sectional views showing the holder and the optical element before and after moving or swinging relative to the plate.

FIG. 3C and FIG. 3D are cross-sectional views showing the holder and the optical element before and after moving or swinging relative to the plate.

### DETAILED DESCRIPTION OF DISCLOSED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as "top," "bottom," "front," "back," etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

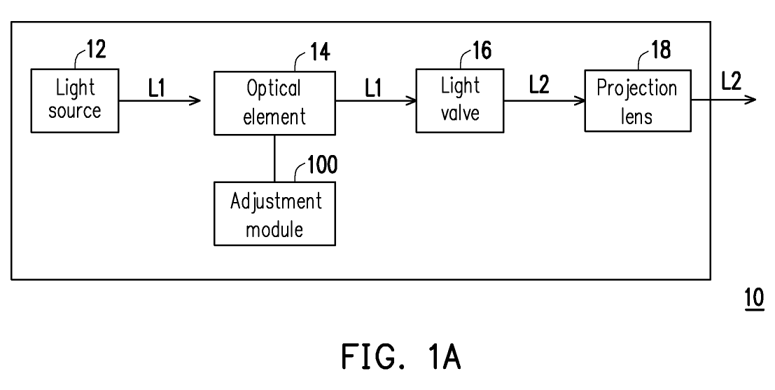

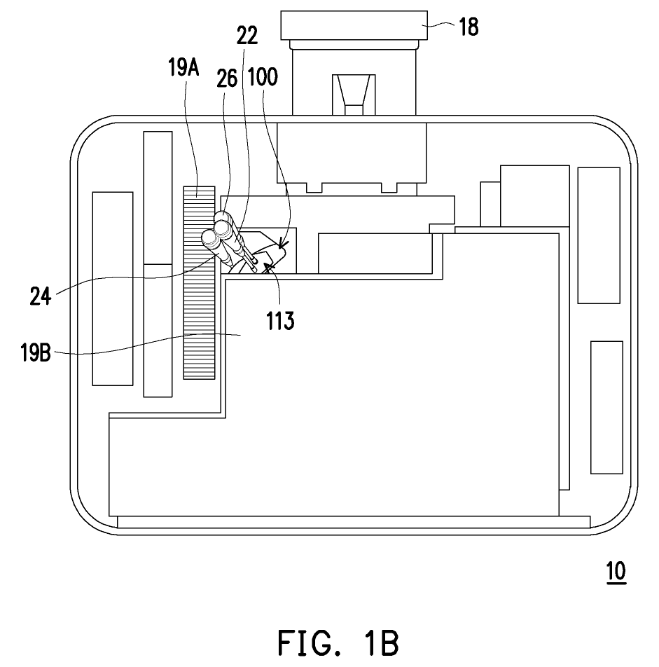

FIG. 1A is a block diagram showing a projection apparatus according to an embodiment of the disclosure. FIG. 1B is a top view showing the interior of the projection apparatus, that is, a state after removing the upper cover of the projection apparatus.

Referring to FIG. 1A and FIG. 1B, in this embodiment, a projection apparatus 10 includes a light source device 12, an optical element 14, an adjustment module 100, a light valve 16, and a projection lens 18. The light source device 12 is configured to provide an illumination beam L1. The optical element 14 is disposed on the adjustment module 100 and located on the transmission path of the illumination beam L1. The adjustment module 100 is configured to adjust the installation position and the installation angle of the optical element 14, thereby changing the transmission direction of the illumination beam L1. The light valve 16 is disposed on the transmission path of the illumination beam L1 and configured to convert the illumination beam L1 into an image beam L2. The projection lens 18 is disposed on the transmission path of the image beam L2 and configured to project the image beam L2 out of the projection apparatus 10.

In detail, the light source device 12 includes at least one light-emitting diode and/or at least one laser diode, for example. The light source device 12 is, for example, a laser diode bank. Specifically, any light source that meets the volume requirements in actual design may be used, and the disclosure is not limited thereto. The optical element 14 is, for example, a reflective mirror or an element with a light reflection function. The light valve 16 is, for example, a reflective light modulator such as a Liquid Crystal On Silicon panel (LCOS panel) and a Digital Micro-mirror Device (DMD). In an embodiment, the light valve 16 is, for example, a transmissive light modulator such as a Transparent Liquid Crystal Panel, an Electro-Optical Modulator, a Magneto-Optic modulator, and an Acousto-Optic Modulator (AOM), but this embodiment is not intended to limit the form and type of the light valve 16. The projection lens 18 is disposed on the transmission path of the image beam L2 and configured to project the image beam L2 out of the projection apparatus 10. The projection lens 18 includes, for example, one optical lens or a combination of multiple optical lenses with refractive power, for example, including various combinations of non-planar lenses such as biconcave lenses, biconvex lenses, concavo-convex lenses, convexo-concave lenses, plano-convex lenses, and plano-concave lenses. In an embodiment, the projection lens 18 may also include planar optical lenses to project the image beam L2 from the light valve 16 out of the projection apparatus 10 by reflection or transmission. Here, this embodiment is not intended to limit the form and type of the projection lens 18.

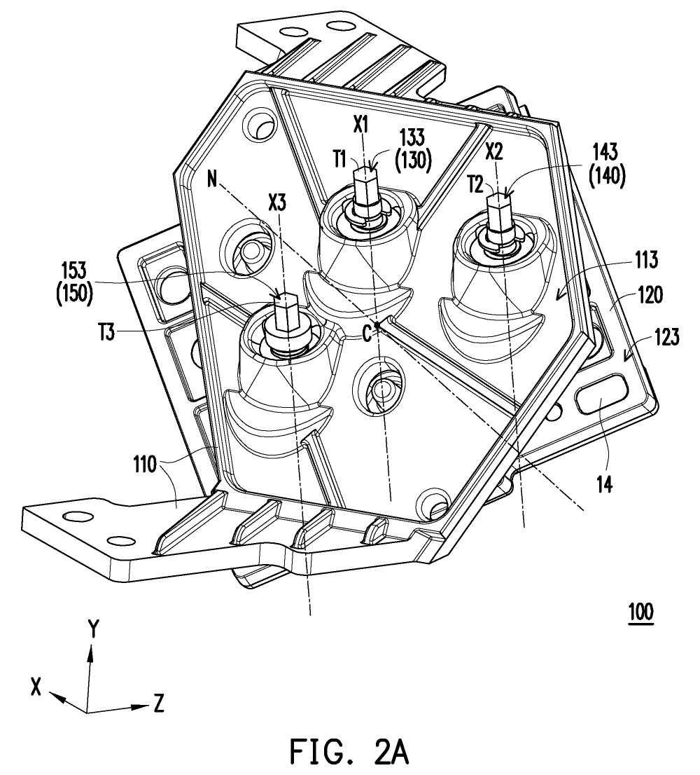

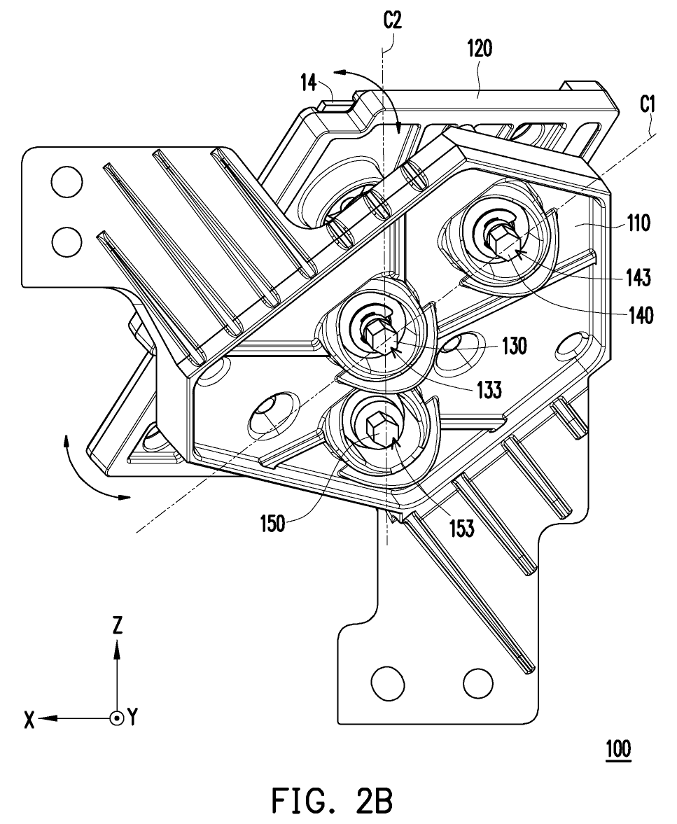

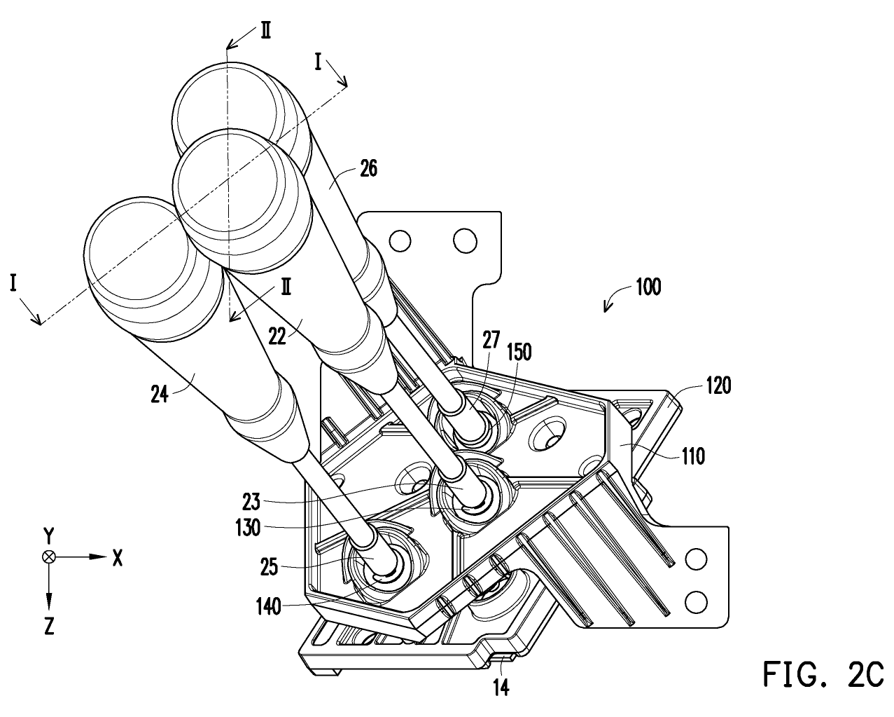

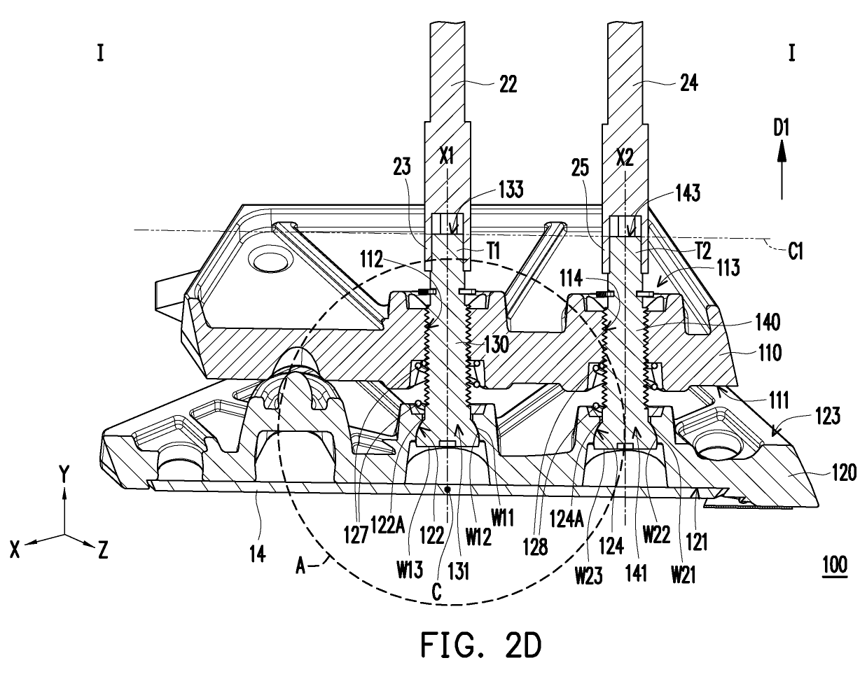

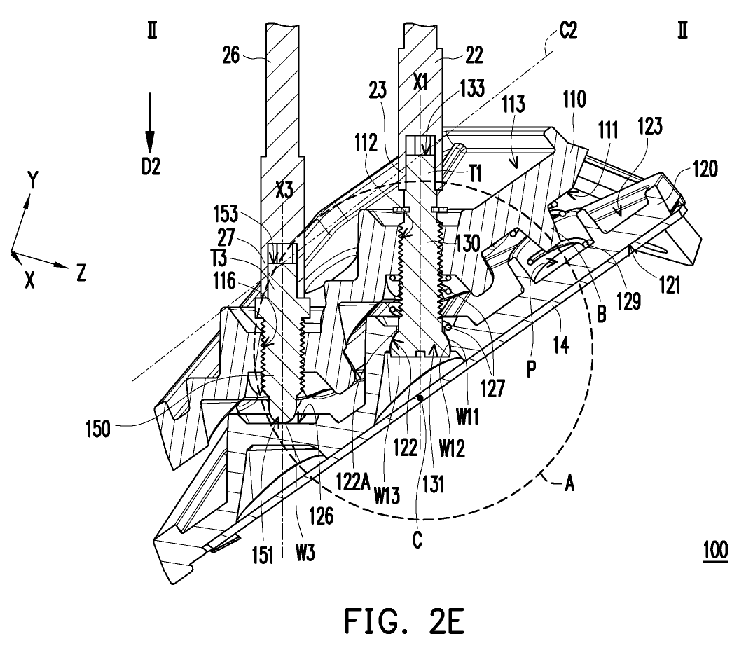

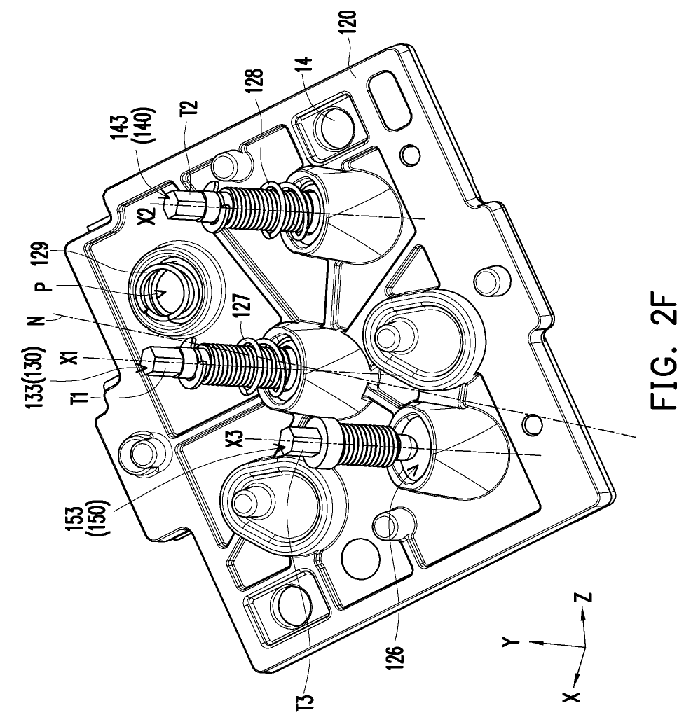

FIG. 2A is a perspective view showing the adjustment module of the projection apparatus of FIG. 1A. FIG. 2B is a perspective view showing the adjustment module of FIG. 2A from another viewing angle. FIG. 2C is a perspective view showing the adjustment module of FIG. 2A engaged with the external adjustment tool. FIG. 2D is a cross-sectional view along line I-I of FIG. 2C. FIG. 2E is a cross-sectional view along line II-II of FIG. 2C. FIG. 2F is a perspective view showing the adjustment module of FIG. 2A with the plate omitted.

Referring to FIG. 2A, FIG. 2B, FIG. 2C, FIG. 2D, and FIG. 2E, in this embodiment, the adjustment module 100 includes a plate 110, a holder 120, a first adjustment bar 130, a second adjustment bar 140, and a third adjustment bar 150. The optical element 14 is fixed on the holder 120, and the holder 120 is located between the plate 110 and the optical element 14. The holder 120 has a first fitting hole 122, a second fitting hole 124, and an abutting surface 126. The first adjustment bar 130 is movably disposed through the plate 110 and configured to move along a first adjustment axis X1. A first end 131 of the first adjustment bar 130 is disposed and fitted in the first fitting hole 122 of the holder 120, and the diameter of the widest part of the first end 131 of the first adjustment bar 130 is larger than the diameter of an opening 122A of the first fitting hole 122 near a fitting surface 123. When the first end 131 of the first adjustment bar 130 is disposed in the first fitting hole 122, the first end 131 of the first adjustment bar 130 is abutted against the peripheral edge of the opening 122A of the first fitting hole 122, making the first adjustment bar 130 unable to leave the first fitting hole 122 along the first adjustment axis X1 toward the plate 110. When the first adjustment bar 130 moves along the first adjustment axis X1, the first end 131 of the first adjustment bar 130 presses against the peripheral edge of the opening 122A of the first fitting hole 122 in the direction toward the plate 110, thereby causing the holder 120 to move the optical element 14. The second adjustment bar 140 is movably disposed through the plate 110 and configured to move along a second adjustment axis X2. A first end 141 of the second adjustment bar 140 is disposed and fitted in the second fitting hole 124, and the diameter of the widest part of the first end 141 of the second adjustment bar 140 is larger than the diameter of an opening 124A of the second fitting hole 124 near the fitting surface 123. When the first end 141 of the second adjustment bar 140 is disposed in the second fitting hole 124, the first end 141 of the second adjustment bar 140 is abutted against the peripheral edge of the narrowest part of the opening 124A of the second fitting hole 124, making the second adjustment bar 140 unable to leave the second fitting hole 124 along the second adjustment axis X2 toward the plate 110. When the second adjustment bar 140 moves along the second adjustment axis X2, the first end 141 of the second adjustment bar 140 presses against the peripheral edge of the opening 124A of the second fitting hole 124 in the direction toward the plate 110, thereby causing the holder 120 to move the optical element 14. The third adjustment bar 150 is movably disposed through the plate 110 and configured to move along a third adjustment axis X3. A first end 151 of the third adjustment bar 150 abuts against the abutting surface 126 of the holder 120. When the third adjustment bar 150 moves along the third adjustment axis X3, the third adjustment bar 150 pushes against the abutting surface 126 of the holder 120, thereby causing the holder 120 to move the optical element 14. When at least one of the first adjustment bar 130, the second adjustment bar 140, and the third adjustment bar 150 moves along the corresponding adjustment axis, the holder 120 and the optical element 14 move or swing relative to the plate 110. Each of the first adjustment axis X1, the second adjustment axis X2, and the third adjustment axis X3 forms an included angle that is not 0 with a normal direction N of the optical element 14. Taking the optical element 14 as a plane reflective mirror as an example, the normal direction N is an axial direction perpendicular to the reflective surface of the reflective mirror.

In other words, the first adjustment bar 130, the second adjustment bar 140, and the third adjustment bar 150 respectively penetrate through the plate 110, with the first ends 131, 141, and 151 thereof oriented toward the holder 120. The first end 131 of the first adjustment bar 130 and the first end 141 of the second adjustment bar 140 are disposed in the first fitting hole 122 and the second fitting hole 124 of the holder 120 to apply forces to the holder 120, while the first end 151 of the third adjustment bar 150 abuts against the abutting surface 126 of the holder 120 to apply a force to the holder 120. Furthermore, the first adjustment bar 130, the second adjustment bar 140, and the third adjustment bar 150 are not perpendicular to the optical element 14.

More specifically, the plate 110 has a first surface 111 and a second surface 113 opposite to the first surface 111, and has a first threaded hole 112, a second threaded hole 114, and a third threaded hole 116 that penetrate through the first surface 111 and the second surface 113. The first threaded hole 112 penetrates through the plate 110 along the first adjustment axis X1, and the first adjustment bar 130 is disposed in the first threaded hole 112. The second threaded hole 114 penetrates through the plate 110 along the second adjustment axis X2, and the second adjustment bar 140 is disposed in the second threaded hole 114. The third threaded hole 116 penetrates through the plate 110 along the third adjustment axis X3, and the third adjustment bar 150 is disposed in the third threaded hole 116. The holder 120 is disposed on the first surface 111 of the plate 110. Referring to FIG. 2A, FIG. 2D, and FIG. 2E, in an embodiment, the extension line of the first adjustment axis X1 passes through the position of a preset center C of the optical element 14. The position of the first threaded hole 112 corresponds to the position of the preset center C of the optical element 14. That is, the axial extension line of the first threaded hole 112 intersects with the position of the preset center C of the optical element 14. Accordingly, the first adjustment bar 130, the second adjustment bar 140, and the third adjustment bar 150 can move by rotating inward or outward relative to the first surface 111 of the plate 110.

Moreover, referring to FIG. 2B, FIG. 2D, and FIG. 2E, the connecting line between the position of the first threaded hole 112 on the plate 110 and the position of the second threaded hole 114 on the plate 110 is a first connecting line C1. The connecting line between the position of the first threaded hole 112 on the plate 110 and the position of the third threaded hole 116 on the plate 110 is a second connecting line C2. In this case, the first connecting line C1 is different from the second connecting line C2.

The holder 120 has a configuration surface 121 and a combining surface 123 opposite to the configuration surface 121. The configuration surface 121 is configured to dispose the optical element 14. The combining surface 123 faces the first surface 111 of the plate 110, and the optical element 14 is fixed on the configuration surface 121. The optical element 14 may be fixed on the configuration surface 121, for example, by clamping means, but the disclosure is not limited thereto. For instance, the optical element 14 may also be fixed on the configuration surface 121 by locking, snap-fitting, or bonding. The center axes of the first fitting hole 122 and the second fitting hole 124 are not perpendicular to the configuration surface 121. The abutting surface 126 is formed to protrude from the combining surface 123 toward the first surface 111 of the plate 110 and is not parallel to the configuration surface 121.

Moreover, referring to FIG. 2D, FIG. 2E, and FIG. 2F, the adjustment module 120 further includes a first compression spring 127, a second compression spring 128, and a third compression spring 129. The first compression spring 127 is disposed between the plate 110 and the holder 120 and sleeved on the first adjustment bar 130. One end of the first compression spring 127 abuts against the first surface 111 of the plate 110, and the other end abuts against the combining surface 123 of the holder 120, to apply a pushing force around the first fitting hole 122 of the holder 120 away from the first surface 111 of the plate 110, so that the first fitting hole 122 maintains contact with the first end 131 of the first adjustment bar 130. The second compression spring 128 is disposed between the plate 110 and the holder 120 and sleeved on the second adjustment bar 140. One end of the second compression spring 128 abuts against the first surface 111 of the plate 110, and the other end abuts against the combining surface 123 of the holder 120, to apply a pushing force around the second fitting hole 124 of the holder 120, so that the second fitting hole 124 maintains contact with the first end 141 of the second adjustment bar 140. The third compression spring 129 is disposed between the plate 110 and the holder 120. A positioning groove P is formed on the combining surface 123 of the holder 120, and a positioning protrusion B is formed on a portion of the first surface 111 of the plate 110 corresponding to the positioning groove P so as to protrude toward the positioning groove P. The position of the positioning groove P allows the first fitting hole 122 to be located between the positioning groove P and the abutting surface 126. In other words, the positioning groove P, the first fitting hole 122, and the abutting surface 126 are roughly arranged in a line in sequence on the holder 120. One end 129a of the third compression spring 129 is disposed in the positioning groove P and abuts against the bottom of the positioning groove P, while the other end is sleeved on the positioning protrusion B of the plate 110 and abuts against the first surface 111 around the positioning protrusion B. The positioning groove P and the positioning protrusion B have an effect of positioning the third compression spring 129. The third compression spring 129 applies a pushing force to the positioning groove P of the holder 120 away from the first surface 111 of the plate 110, causing the abutting surface 126 of the holder 120, which is located on the opposite side of the first fitting hole 122, to abut against and maintain contact with the first end 151 of the third adjustment bar 150.

Referring to FIG. 2D and FIG. 2E, the outer wall shape of the first end 131 of the first adjustment bar 130 fits the inner wall shape of the first fitting hole 122 of the holder 120. The first adjustment bar 130 is mainly configured to apply a pulling force in the first direction D1 to the first fitting hole 122 along the first adjustment axis X1, to pull the holder 120 closer to the plate 110 (for example, when the first adjustment bar 130 is moved relative to the first surface 111 of the plate 110). In other words, in an embodiment, the first adjustment bar 130 is a pull bar. The first adjustment bar 130 has a second end 133 opposite to the first end 131. The first end 131 has an arc-shaped outer wall W11 that gradually expands away from the second end 133, and the first fitting hole 122 has an arc-shaped inner wall W12 that gradually narrows from the configuration surface 121 toward the combining surface 123. The arc-shaped outer wall W11 of the first adjustment bar 130 can be slidably in contact with the arc-shaped inner wall W12 of the first fitting hole 122, enabling the first adjustment bar 130 to have a first swing angle range relative to the combining surface 123 of the holder 120. Moreover, since at least part of the radial width of the arc-shaped outer wall W11 is larger than the radial width of the narrowest part of the arc-shaped inner wall W12 of the first fitting hole 122, the first end 131 of the first adjustment bar 130 is restricted by the arc-shaped inner wall W12 of the first fitting hole 122 and unable to leave the first fitting hole 122 from the combining surface 123. In other words, the first end 131 of the first adjustment bar 130 cannot leave from the opening 122A of the first fitting hole 122. In addition, the first end 131 of the first adjustment bar 130 also has a flat top surface W13, connected to the edge of the arc-shaped outer wall W11 away from the second end 131. In short, the fit between the first end 131 of the first adjustment bar 130 and the first fitting hole 122 is a type of ball and hole fit.

Further, referring to FIG. 2B to FIG. 2E, the first adjustment bar 130 of the adjustment module 100 is also configured to fit an engagement structure 23 of an external adjustment tool 22 for the user to operate the first adjustment bar 130. The second end 133 of the first adjustment bar 130 protrudes through the second surface 113 of the plate 110 and is exposed on the second surface 113, and has an adjustment tool engagement structure T1 for engaging with the engagement structure 23 of the external adjustment tool 22. The adjustment tool engagement structure T1 is, for example, an external hexagonal column structure as shown in FIG. 2B to FIG. 2E, but the disclosure is not limited thereto. For instance, the adjustment tool engagement structure T1 may also be an external square column structure, an internal hexagonal groove structure, a cross groove structure, a straight groove structure, or other appropriate structures that can engage with the corresponding external adjustment tool 22 to operate the first adjustment bar 130.

The fitting means between the second adjustment bar 140 and the second fitting hole 124 is similar to the fitting means between the first adjustment bar 130 and the first fitting hole 122, which will be described in detail below.

Referring to FIG. 2D and FIG. 2E, the outer wall shape of the first end 141 of the second adjustment bar 140 fits the inner wall shape of the second fitting hole 124 of the holder 120. The first end 141 of the second adjustment bar 140 is mainly configured to apply a pulling force in the first direction D1 to the second fitting hole 124 along the second adjustment axis X2, to pull the holder 120 closer to the plate 110 (for example, when the second adjustment bar 140 is moved relative to the first surface 111 of the plate 110). In other words, in an embodiment, the second adjustment bar 140 is a pull bar. The second adjustment bar 140 has a second end 143 opposite to the first end 141 of the second adjustment bar 140. The first end 141 has an arc-shaped outer wall W21 that gradually expands away from the second end 143 of the second adjustment bar 140, and the second fitting hole 124 has an arc-shaped inner wall W22 that gradually narrows from the configuration surface 121 toward the combining surface 123. The arc-shaped outer wall W21 of the second adjustment bar 140 can be slidably in contact with the arc-shaped inner wall W22 of the second fitting hole 124, enabling the second adjustment bar 140 to have a second swing angle range relative to the combining surface 123 of the holder 120 (that is, the angle range of swinging along the first connecting line C1). Moreover, since at least part of the radial width of the arc-shaped outer wall W21 is larger than the radial width of the narrowest part of the arc-shaped inner wall W22 of the second fitting hole 124, the first end 141 of the second adjustment bar 140 is restricted by the arc-shaped inner wall W22 of the second fitting hole 124 and unable to leave the second fitting hole 124 from the combining surface 123. In other words, the first end 141 of the second adjustment bar 140 cannot leave from the opening 124A of the second fitting hole 124. In addition, the first end 141 of the second adjustment bar 140 also has a flat top surface W23, connected to the edge of the arc-shaped outer wall W21 away from the second end 143. In short, the fit between the first end 141 of the second adjustment bar 140 and the second fitting hole 124 is a type of ball and hole fit.

In addition, referring to FIG. 2B to FIG. 2E, the second adjustment bar 140 of the adjustment module 100 is also configured to fit an engagement structure 25 of an external adjustment tool 24 for the user to operate the second adjustment bar 140. The second end 143 of the second adjustment bar 140 protrudes through the second surface 113 of the plate 110 and is exposed on the second surface 113, and has an adjustment tool engagement structure T2 for engaging with the engagement structure 25 of the external adjustment tool 24. The adjustment tool engagement structure T2 is, for example, an external hexagonal column structure as shown in FIG. 2B, but the disclosure is not limited thereto. For instance, the adjustment tool engagement structure T2 may also be an external square column structure, an internal hexagonal groove structure, a cross groove structure, a straight groove structure, or other appropriate structures that can engage with the corresponding external adjustment tool 24 to operate the second adjustment bar 140.

It should be noted that when the first adjustment bar 130 or the second adjustment bar 140 moves along a second direction D2 opposite to the first direction D1 (for example, the first adjustment bar 130 or the second adjustment bar 140 is moved relative to the first surface 111 of the plate 110 in a screwing-in direction), the first adjustment bar 130 or the second adjustment bar 140 does not apply a pulling force to the holder 120. At this time, the first compression spring 127 or the second compression spring 128 applies a pushing force to the holder 120 in substantially along the second direction D2 and causes the holder 102 to move or swing, so as to keep the first fitting hole 122 in contact with the first end 131 of the first adjustment bar 130 or the second fitting hole 124 in contact with the first end 141 of the second adjustment bar 140, thereby adjusting the optical element 14.

The first end 151 of the third adjustment bar 150 abuts against the abutting surface 126 of the holder 120. In an embodiment, the third adjustment bar 150 is mainly configured to apply a pushing force to the holder 120 by the abutting surface 126 to push the holder 120 away from the plate 110. In other words, the third adjustment bar 150 is a push bar. The first end 151 of the third adjustment bar 150 has a convex arc surface W3, and the convex arc surface W3 is tangent to the abutting surface 126 of the holder 120. In an embodiment, the convex arc surface W3 is, for example, a hemispherical surface.

The third adjustment bar 150 has a second end 153 opposite to the first end 151 of the third adjustment bar 150. In addition, the third adjustment bar 150 of the adjustment module 100 is configured to fit an engagement structure 27 of an external adjustment tool 26. The second end 153 of the third adjustment bar 150 has an adjustment tool engagement structure T3 for engaging with the engagement structure 27 of the external adjustment tool 26. The adjustment tool engagement structure T3 may be, for example, an external hexagonal column structure, a cross groove, a straight groove, or other appropriate structures.

Further, referring to FIG. 2B to FIG. 2E, when the second adjustment bar 140 is adjusted in the screwing-out direction or screwing-in direction, causing the second adjustment bar 140 to move in the first direction D1 or the second direction D2, the holder 120 swings about an axis formed by the connecting line of the first fitting hole 122 and the abutting surface 126 (substantially parallel to the second connecting line C2), thereby driving the optical element 14 to change angle. When the third adjustment bar 150 is adjusted in the screwing-out direction or screwing-in direction, causing the third adjustment bar 150 to move in the first direction D1 or the second direction D2, the holder 12 swings about an axis formed by the connecting line of the first fitting hole 122 and the second fitting hole 124 (substantially parallel to the first connecting line C1), thereby driving the optical element 14 to change angle.

Referring to FIG. 1B, it should be noted that, in order to allow maintenance personnel to directly use the external adjustment tools 22, 24, and 26 to engage with the adjustment module 100 for adjusting the optical element 14 without interference from other mechanism parts 19A and 19B after opening the casing of the projection apparatus 10, the space between the extension of the first adjustment bar 130, the second adjustment bar 140, and the third adjustment bar 150 away from the second surface 113 of the plate 110 and the casing of the projection apparatus 10 (such as the space where the adjustment tools 22, 24, and 26 are located in FIG. 1B) is preferably a cavity. Alternatively, referring to FIG. 2A as well, the space between the second end 133 of the first adjustment bar 130, the second end 143 of the second adjustment bar 140, and the second end 153 of the third adjustment bar 150 and the casing of the projection apparatus 10 is a cavity. That is, there are no other mechanism parts 19A and 19B in the aforementioned space, so maintenance personnel are not required to remove other mechanism parts 19A and 19B first when adjusting the optical element 14. In FIG. 1B, the other mechanism part 19A is, for example, a heat dissipation module, and the other mechanism part 19B is, for example, a motherboard.

Furthermore, according to the adjustment module 100 of the disclosure, the angles between the first adjustment bar 130, the second adjustment bar 140, and the third adjustment bar 150 and the optical element 14 are not necessarily vertical. The directions of the first to third adjustment axes X1, X2, and X3 may be adjusted according to the configuration of other mechanism parts 19 of the projection apparatus 10, which allows for more flexibility in the design and configuration of the cavity or reduces the required size of the cavity. The adjustment module 100 of this embodiment solves the problems of poor space utilization and operational difficulty in the related art, thereby improving the convenience in maintenance.

Referring to FIG. 2D and FIG. 2E, as shown in FIG. 2D, when the first end 131 of the first adjustment bar 130 (corresponding to the preset center C of the optical element 14) is fixed, and the second adjustment bar 140 is moved in the screwing-in direction or screwing-out direction to adjust the optical element 14, the movement path of the first end 141 of the second adjustment bar 140 (coinciding with the second adjustment axis X2) approaches a tangent plane of an imaginary sphere A. This imaginary sphere A has the center at the first end 131 of the first adjustment bar 130 (corresponding to the preset center C of the optical element 14). As shown in FIG. 2E, similarly when the first adjustment bar 130 is fixed, and the third adjustment bar 150 is moved in the screwing-in direction or screwing-out direction to adjust the optical element 14, the movement path of the first end 151 of the third adjustment bar 150 (coinciding with the third adjustment axis X3) deviates from and is not parallel to the tangent plane of the imaginary sphere A, which causes a relatively large angle change between the third adjustment axis X3 of the third adjustment bar 150 and the abutting surface 126 of the holder 120. Therefore, the third adjustment bar 150 contacts the abutting surface 126 of the holder by the convex arc surface W3, thus allowing for a larger relative angle change.

Furthermore, when the first end 131 of the first adjustment bar 130 is fixed and the second adjustment bar 140 is adjusted, the movement path of the second adjustment bar 140 moves along the tangent plane of the imaginary sphere A. At this time, the contact point between the third adjustment bar 150 and the abutting surface 126 of the holder 120 moves away from the tangent plane of the imaginary sphere A. Therefore, the first end 151 of the third adjustment bar 150 that comes into contact with the contact point of the holder 120 is designed with the convex arc surface W3 to allow for a larger relative rotation angle or movement range of the contact point between the third adjustment bar 150 and the abutting surface 126 of the holder 120. This design avoids interference at the fitting position between the third adjustment bar 150 and the holder 120 when adjusting the second adjustment bar 140, which may otherwise increase adjustment resistance or make adjustment unable to be performed.

The following further describes a situation where the first adjustment bar 130 and the second adjustment bar 140, or the first adjustment bar 130 and the third adjustment bar 150, are adjusted simultaneously, causing a relative distance change between the holder 120 and the plate 110.

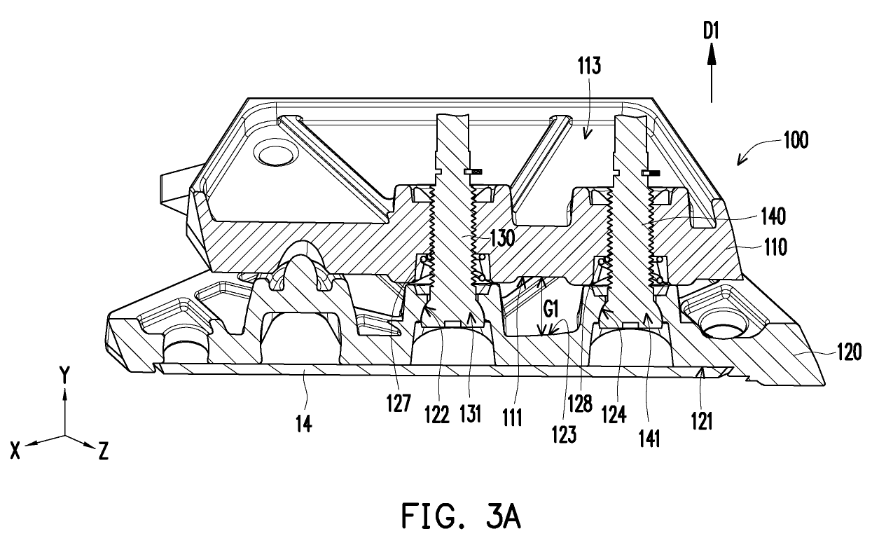

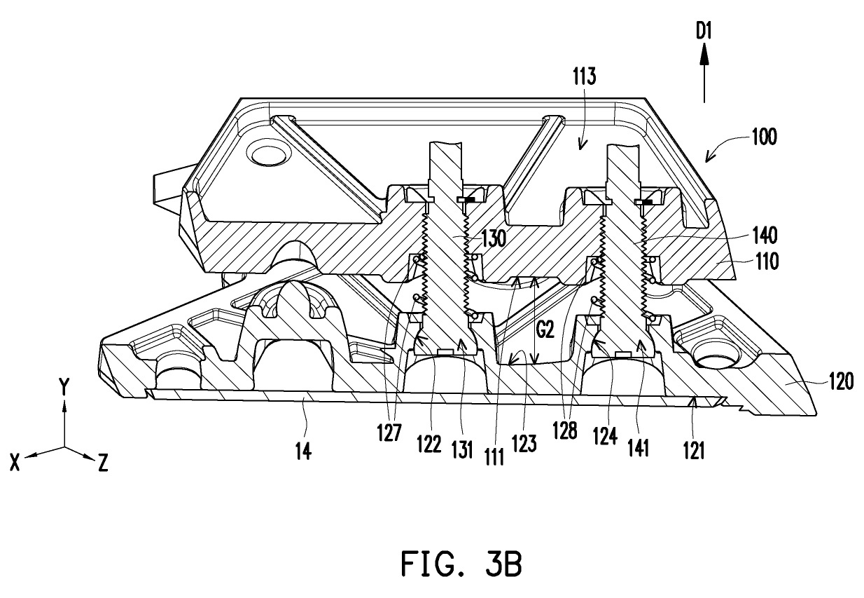

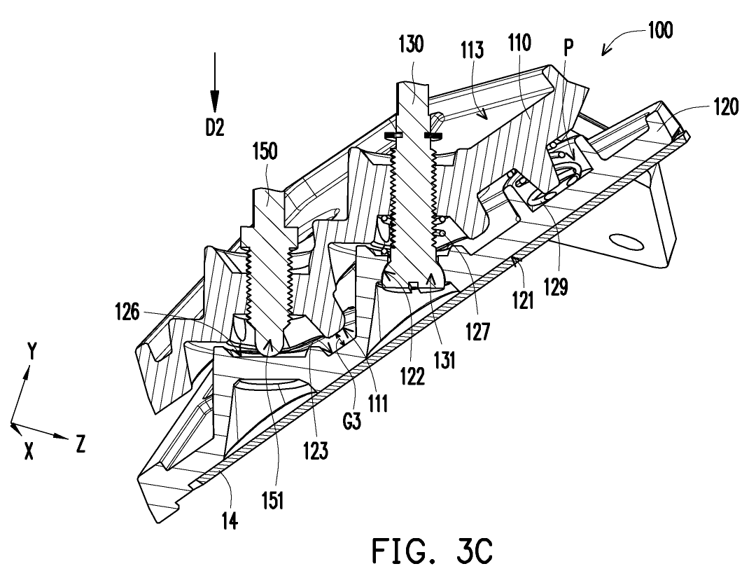

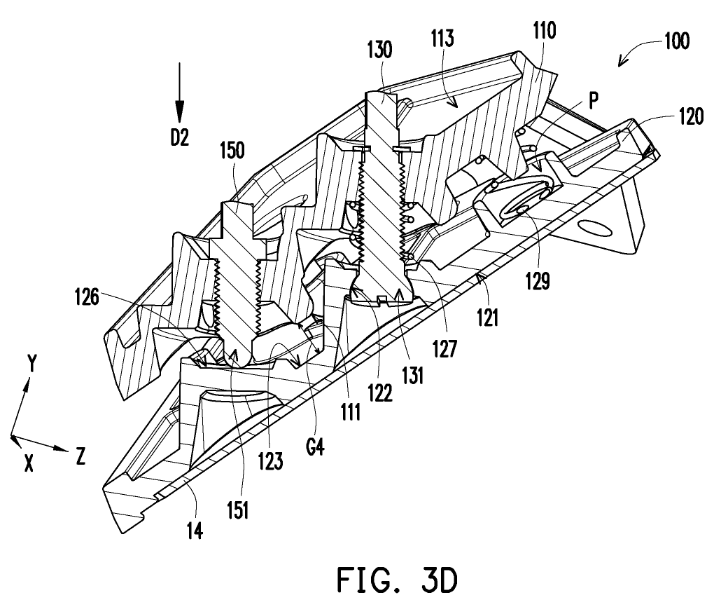

FIG. 3A is a cross-sectional view showing the holder 120 and the plate 110 in a closer adjustment state caused by the first adjustment bar 130 and the second adjustment bar 140; and FIG. 3B is a cross-sectional view showing the holder 120 and the plate 110 in a farther adjustment state caused by the first adjustment bar 130 and the second adjustment bar 140.

As can be seen from FIG. 3A and FIG. 3B, by adjusting the first adjustment bar 130 and the second adjustment bar 140, a distance between the first surface 111 of the plate 110 and the combining surface 123 of the holder 120 may vary between the gap G1 as shown in FIG. 3A and the gap G2 as shown in FIG. 3B.

FIG. 3C is a cross-sectional view showing the holder 120 and the plate 110 in another closer adjustment state caused by the first adjustment bar 130 and the third adjustment bar 150; and FIG. 3D is a cross-sectional view showing the holder 120 and the plate 110 in another farther adjustment state caused by the first adjustment bar 130 and the third adjustment bar 150.

As can be seen from FIG. 3C and FIG. 3D, by adjusting the first adjustment bar 130 and the third adjustment bar 150, a distance between the first surface 111 of the plate 110 and the combining surface 123 of the holder 120 may vary between the gap G3 as shown in FIG. 3C and the gap G4 as shown in FIG. 3D.

In summary, with use of the ball and hole fit between the first adjustment bar 130, the second adjustment bar 140, and the first fitting holes 122 and 124, and the arc-shaped third adjustment bar 150 tangent to the planar abutting surface 126, the disclosure makes it possible to effectively adjust the optical element 14 in a state where the first adjustment bar 130, the second adjustment bar 140, and the third adjustment bar 150 are not perpendicular to the optical element 14, thereby greatly increasing the design range of the included angle between the first adjustment bar 130, the second adjustment bar 140, the third adjustment bar 150 and the optical element 14. As a result, the external adjustment tools 22, 24, and 26 may operate in conjunction with the first adjustment bar 130, the second adjustment bar 140, and the third adjustment bar 150 without being perpendicular to the optical element 14. That is to say, even if the design angle of the optical element 14 has a large inclination with respect to the upper cover of the projection apparatus (parallel to the paper surface in FIG. 1B), the external adjustment tools 22, 24, and 26 can still adjust the optical element 14 at an angle nearly perpendicular to the upper cover of the projection apparatus, which solves the problems of poor space utilization and operational difficulty caused by inclined adjustment bars in the related art.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An adjustment module, configured to adjust an installation position and an installation angle of an optical element, and comprising:
a plate, a holder, a first adjustment bar, a second adjustment bar, and a third adjustment bar, wherein
the optical element is fixed on the holder, and the holder is located between the plate and the optical element;
the holder has a first fitting hole, a second fitting hole, and an abutting surface;
the first adjustment bar is movably disposed through the plate and configured to move along a first adjustment axis, and a first end of the first adjustment bar is disposed and fitted in the first fitting hole of the holder;
the second adjustment bar is movably disposed through the plate and configured to move along a second adjustment axis, and a first end of the second adjustment bar is disposed and fitted in the second fitting hole;
the third adjustment bar is movably disposed through the plate and configured to move along a third adjustment axis, and a first end of the third adjustment bar abuts against the abutting surface of the holder; wherein
when the first adjustment bar moves along the first adjustment axis, the second adjustment bar moves along the second adjustment axis, and/or the third adjustment bar moves along the third adjustment axis, the holder and the optical element move or swing relative to the plate; and
each of the first adjustment axis, the second adjustment axis, and the third adjustment axis forms an included angle that is not 0 with a normal direction of the optical element.

2. The adjustment module according to claim 1, wherein the plate has a first surface and a second surface opposite to the first surface, and has a first threaded hole, a second threaded hole, and a third threaded hole penetrating through the first surface and the second surface,
the first threaded hole penetrates through the plate along the first adjustment axis, the first adjustment bar is disposed in the first threaded hole, the second threaded hole penetrates through the plate along the second adjustment axis, the second adjustment bar is disposed in the second threaded hole, the third threaded hole penetrates through the plate along the third adjustment axis, the third adjustment bar is disposed in the third threaded hole, and the holder is disposed on the first surface of the plate.

3. The adjustment module according to claim 2, wherein when the first adjustment bar is rotated to move along the first adjustment axis in a first direction, the first end of the first adjustment bar pushes against the first fitting hole to drive the holder to move toward the first surface of the plate; when the second adjustment bar is rotated to move along the second adjustment axis in the first direction, the first end of the second adjustment bar pushes against the second fitting hole to drive the holder to move toward the first surface of the plate; and when the third adjustment bar is rotated to move along the third adjustment axis in a second direction, the first end of the third adjustment bar pushes against the abutting surface of the holder to push the holder away from the first surface of the plate, wherein the first direction is opposite to the second direction.

4. The adjustment module according to claim 2, wherein a connecting line between a position of the first threaded hole on the plate and a position of the second threaded hole on the plate is a first connecting line, and a connecting line between the position of the first threaded hole on the plate and a position of the third threaded hole on the plate is a second connecting line, and the first connecting line is different from the second connecting line.

5. The adjustment module according to claim 1, wherein
an outer wall shape of the first end of the first adjustment bar fits an inner wall shape of the first fitting hole of the holder, and the first adjustment bar applies a pulling force in the first direction to the first fitting hole along the first adjustment axis; and
an outer wall shape of the first end of the second adjustment bar fits an inner wall shape of the second fitting hole of the holder, and the first end of the second adjustment bar applies a pulling force in the first direction to the second fitting hole along the second adjustment axis.

6. The adjustment module according to claim 1, wherein the holder has a configuration surface and a combining surface opposite to the configuration surface, and the configuration surface is configured to dispose the optical element;
the first adjustment bar has a second end opposite to the first end of the first adjustment bar, the second adjustment bar has a second end opposite to the first end of the second adjustment bar, and the third adjustment bar has a second end opposite to the first end of the third adjustment bar;
the first end of the first adjustment bar has an arc-shaped outer wall that gradually expands away from the second end of the first adjustment bar, and the first fitting hole has an arc-shaped inner wall that gradually narrows from the configuration surface toward the combining surface; the arc-shaped outer wall of the first adjustment bar is slidably in contact with the arc-shaped inner wall of the first fitting hole, enabling the first adjustment bar to have a first swing angle range relative to the combining surface of the holder; and
the first end of the second adjustment bar has an arc-shaped outer wall that gradually expands away from the second end of the second adjustment bar, and the second fitting hole has an arc-shaped inner wall that gradually narrows from the configuration surface toward the combining surface; the arc-shaped outer wall of the second adjustment bar is slidably in contact with the arc-shaped inner wall of the second fitting hole, enabling the second adjustment bar to have a second swing angle range relative to the combining surface of the holder.

7. The adjustment module according to claim 1, wherein the first end of the third adjustment bar has a convex arc surface, and the convex arc surface is tangent to the abutting surface of the holder.

8. The adjustment module according to claim 1, wherein an extension line of the first adjustment axis passes through a position of a preset center of the optical element.

9. The adjustment module according to claim 1, wherein the holder has a configuration surface and a combining surface opposite to the configuration surface, the combining surface faces the first surface of the plate, and the optical element is fixed on the configuration surface.

10. The adjustment module according to claim 9, wherein
a center axis of the first fitting hole and a center axis of the second fitting hole are not perpendicular to the configuration surface; and
the abutting surface is not parallel to the configuration surface.

11. The adjustment module according to claim 1, further comprising:
a first compression spring disposed between the plate and the holder and sleeved on the first adjustment bar, wherein the first compression spring applies a pushing force around the first fitting hole of the holder, so that the first fitting hole maintains contact with the first end of the first adjustment bar;
a second compression spring disposed between the plate and the holder and sleeved on the second adjustment bar, wherein the second compression spring applies a pushing force around the second fitting hole of the holder, so that the second fitting hole maintains contact with the first end of the second adjustment bar; and
a third compression spring disposed between the plate and the holder, wherein the holder has a positioning groove, the first fitting hole is located between the positioning groove and the abutting surface, one end of the third compression spring is disposed in the positioning groove, and the third compression spring applies a pushing force to the positioning groove of the holder, so that the abutting surface of the holder maintains contact with the first end of the third adjustment bar.

12. The adjustment module according to claim 2, wherein the adjustment module is configured to fit an engagement structure of an external adjustment tool, wherein
the first adjustment bar has a second end opposite to the first end of the first adjustment bar, the second adjustment bar has a second end opposite to the first end of the second adjustment bar, the third adjustment bar has a second end opposite to the first end of the third adjustment bar; and
the second end of the first adjustment bar, the second end of the second adjustment bar, and the second end of the third adjustment bar are respectively exposed on the second surface of the plate, and each comprise an adjustment tool engagement structure.

13. The adjustment module according to claim 3, wherein the adjustment module is configured to fit an engagement structure of an external adjustment tool, wherein
the first adjustment bar has a second end opposite to the first end of the first adjustment bar, the second adjustment bar has a second end opposite to the first end of the second adjustment bar, the third adjustment bar has a second end opposite to the first end of the third adjustment bar; and
the second end of the first adjustment bar, the second end of the second adjustment bar, and the second end of the third adjustment bar are respectively exposed on the second surface of the plate, and each comprise an adjustment tool engagement structure.

14. The adjustment module according to claim 1, wherein the optical element is a reflective mirror.

15. A projection apparatus, comprising:
a light source, an optical element, an adjustment module, a light valve, and a projection lens, wherein
the light source is configured to provide an illumination beam;
the adjustment module is disposed on a transmission path of the illumination beam and configured to adjust an installation position and an installation angle of the optical element, and the adjustment module comprises a plate, a holder, a first adjustment bar, a second adjustment bar, and a third adjustment bar, wherein
the optical element is fixed on the holder, and the holder is located between the plate and the optical element;
the holder has a first fitting hole, a second fitting hole, and an abutting surface;
the first adjustment bar is movably disposed through the plate and configured to move along a first adjustment axis, and a first end of the first adjustment bar is disposed and fitted in the first fitting hole of the holder;
the second adjustment bar is movably disposed through the plate and configured to move along a second adjustment axis, and a first end of the second adjustment bar is disposed and fitted in the second fitting hole; and
the third adjustment bar is movably disposed through the plate and configured to move along a third adjustment axis, and a first end of the third adjustment bar abuts against the abutting surface of the holder; wherein
when the first adjustment bar moves along the first adjustment axis, the second adjustment bar moves along the second adjustment axis, and/or the third adjustment bar moves along the third adjustment axis, the holder and the optical element move or swing relative to the plate; and
each of the first adjustment axis, the second adjustment axis, and the third adjustment axis forms an included angle that is not 0 with a normal direction of the optical element;
the light valve is disposed on the transmission path of the illumination beam and configured to convert the illumination beam into an image beam; and
the projection lens is disposed on a transmission path of the image beam and configured to project the image beam out of the projection apparatus.
